(19) United States
(12) Patent Application Publication
(10) Pub. No.: US 2026/0145971 A1
(43) Pub. Date: May 28, 2026

(54) METHOD OF WATER PURIFICATION

(71) Applicant: KING FAHD UNIVERSITY OF PETROLEUM AND MINERALS, Dhahran (SA)

(72) Inventors: Sagheer A. ONAIZI, Dhahran (SA); Muhammad Shariq VOHRA, Dhahran (SA); Waleed K. AL-NOWAISER, Dhahran (SA)

(73) Assignee: KING FAHD UNIVERSITY OF PETROLEUM AND MINERALS, Dhahran (SA)

(21) Appl. No.: 18/959,828

(22) Filed: Nov. 26, 2024

(51) Int. Cl. C02F 1/461; C02F 1/28; C02F 1/46; C02F 101/20; C02F 101/34; C02F 103/08

(52) U.S. Cl. CPC C02F 1/46114; C02F 1/281; C02F 1/288; C02F 1/4604; C02F 2101/20; C02F 2101/345; C02F 2101/40; C02F 2103/08

(57) ABSTRACT

A method of desalinating an aqueous solution using a nanocomposite material includes contacting electrodes with an aqueous solution. The aqueous solution includes one or more pollutants and the nanocomposite material. The nanocomposite material includes graphene oxide and zeolitic imidazolate framework-7 (ZIF-7). The nanocomposite material is in the form of particles with the longest dimension ranging from 0.5 to 5 μm. The method further includes applying a potential to the electrodes and adsorbing the one or more pollutants on the nanocomposite material.

### STATEMENT REGARDING PRIOR DISCLOSURE BY THE INVENTORS

Aspects of the present disclosure are described in Al-Nowaiser, W., Vohra, M., Onaizi, S., “Hybrid electrocoagulation/adsorption system using aluminum electrodes and novel GO@ZIF-7 nanocomposite for the effective removal of Pb(II) from wastewater” Separation and Purification Technology, Volume 350, 2024, which is incorporated herein by reference in its entirety.

### STATEMENT OF ACKNOWLEDGEMENT

Support provided by the Civil and Environmental Engineering Department, the Chemical Engineering Department, and the Deanship of Research Oversight and Coordination at King Fahd University of Petroleum and Minerals is gratefully acknowledged.

### BACKGROUND

### Technical Field

The present disclosure is directed to a method of water purification, and particularly a method of removing pollutants from an aqueous hybrid solution with a electrocoagulation/adsorption (EC/A) system-which uses an Al electrode as a working electrode and a graphene oxide (GO)/zeolitic imidazolate framework-7 (ZIF-7) (GO@ZIF-7) nanocomposite as an adsorbent.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present disclosure.

With the rapid development of global industries, the discharge of industrial organic wastewater has become a major contributor to severe water pollution, posing risks to natural water bodies. Addressing water pollution has therefore become an urgent priority for rising population.

Traditional methods for treating industrial wastewater includes advanced oxidation, membrane separation, and adsorption techniques. Among these, the adsorption method is the most common due to its simplicity, low cost, and high efficiency. The choice of adsorbent will determine the efficacy of this method. Conventional adsorbents, such as activated carbon, natural minerals, and industrial/agricultural wastes, have limitations in terms of specific surface area and active sites, reducing their adsorption efficiency. Also, the performance of adsorption materials is affected by water temperature which necessitates the development of adsorbents that can maintain high performance across varying temperature ranges.

Electrocoagulation is an effective water treatment process that utilizes electrical current to remove pollutants from wastewater. By immersing conductive electrodes, typically aluminum or iron, in the water and applying an electric current, metal ions are released, forming metal hydroxides and flocs that trap suspended solids and heavy metals. The process enhances particle aggregation and settling, often aided by generated bubbles that float aggregates to the surface for removal. While electrocoagulation offers advantages such as minimal chemical use and rapid treatment, it also has limitations, including electrode wear, energy consumption, and potential pH variability.

Recently, metal-organic frameworks (MOFs) have emerged as promising adsorbents due to their unique porous nanostructure. MOFs are formed by the self-assembly of metal ions or clusters with organic ligands. Zeolite-like imidazolate frameworks (ZIFs), a subclass of MOFs, offer high specific surface areas, adjustable frameworks, and enhanced hydrothermal and chemical stability, making them ideal for applications in adsorption, catalysis, and beyond.

While MOFs have potential for removing water pollutants due to their high surface area and tunable porosity, they also face notable drawbacks. Many MOFs exhibit stability issues, being sensitive to moisture, heat, and harsh chemicals, which can lead to degradation. They may lack the mechanical strength necessary for practical applications and have complex synthesis processes that hinder large-scale production. Additionally, the cost of raw materials can be high, and achieving selectivity for target pollutants is challenging. Regeneration of MOFs after adsorption can be complicated, and environmental concerns arise from the use of certain metal ions.

Accordingly, one object of the present disclosure is to provide an efficient method for removal of organic and inorganic pollutants from wastewater that will overcome the limitations of the art.

### SUMMARY

In an exemplary embodiment, a method of desalinating an aqueous solution using a nanocomposite material is described. The method includes contacting electrodes with an aqueous solution. An aqueous solution includes one or more pollutants and the nanocomposite material. The nanocomposite material includes graphene oxide and zeolitic imidazolate framework-7 (ZIF-7). The nanocomposite material is in the form of particles with the longest dimension ranging from 0.5 to 5 μm. The method further includes applying a potential to the electrodes. The method further includes adsorbing the one or more pollutants on the nanocomposite material.

In some embodiments, the graphene oxide is present in the nanocomposite material in an amount of 25 to 40 percent by weight (wt. %) based on a total weight of the nanocomposite material.

In some embodiments, the graphene oxide is present in the nanocomposite material in an amount of 30 to 35 percent by weight (wt. %) based on the total weight of the nanocomposite material.

In some embodiments, the nanocomposite material has a lead (Pb(II)) removal efficiency of 15 to 25% after 15 minutes based on an initial concentration of 100 mg/L of lead in the aqueous solution.

In some embodiments, the nanocomposite material has a lead (Pb(II)) removal efficiency of 30 to 45% after 30 minutes based on an initial concentration of 100 mg/L of lead in the aqueous solution.

In some embodiments, the nanocomposite material has a lead (Pb(II)) removal efficiency of 70 to 85% after 60 minutes based on an initial concentration of 100 mg/L of lead in the aqueous solution.

In some embodiments, the nanocomposite material has a lead (Pb(II)) removal efficiency of 80 to 95% after 90 minutes based on an initial concentration of 100 mg/L of lead in the aqueous solution.

In some embodiments, the nanocomposite material has a methyl orange removal efficiency of 30 to 45% after 15 minutes based on an initial concentration of 100 mg/L of methyl orange in the aqueous solution.

In some embodiments, the nanocomposite material has a methyl orange removal efficiency of 40 to 55% after 30 minutes based on an initial concentration of 100 mg/L of methyl orange in the aqueous solution.

In some embodiments, the nanocomposite material has a methyl orange removal efficiency of 60 to 75% after 60 minutes based on an initial concentration of 100 mg/L of methyl orange in the aqueous solution.

In some embodiments, the nanocomposite material has a methyl orange removal efficiency of 75 to 90% after 90 minutes based on an initial concentration of 100 mg/L of methyl orange in the aqueous solution.

In some embodiments, the nanocomposite material has an o-cresol removal efficiency of 25 to 35% after 15 minutes based on an initial concentration of 100 mg/L of o-cresol in the aqueous solution.

In some embodiments, the nanocomposite material has an o-cresol removal efficiency of 35 to 50% after 30 minutes based on an initial concentration of 100 mg/L of o-cresol in the aqueous solution.

In some embodiments, the nanocomposite material has an o-cresol removal efficiency of 60 to 75% after 60 minutes based on an initial concentration of 100 mg/L of o-cresol in the aqueous solution.

In some embodiments, the nanocomposite material has an o-cresol removal efficiency of 75 to 90% after 90 minutes based on an initial concentration of 100 mg/L of o-cresol in the aqueous solution.

In some embodiments, the applied potential has a current density of 0.1 to 2 mA/cm².

In some embodiments, the applied potential has a current density of 0.5 to 1.5 mA/cm².

In some embodiments, the applied potential has a current density of 0.8 to 1.2 mA/cm².

In some embodiments, the applied potential is zero and the nanocomposite material has a lead (Pb(II)) removal efficiency of 60 to 80% after 90 minutes based on an initial concentration of 100 mg/L of lead in the aqueous solution.

In some embodiments, the applied potential is zero and the nanocomposite material has a methyl orange removal efficiency of 50 to 65% after 90 minutes based on an initial concentration of 100 mg/L of methyl orange in the aqueous solution.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a flowchart diagram of a method of water purification, according to certain embodiments.

FIG. 1B is a schematic diagram of an experimental setup including a magnetic stirrer controller, baffles, aluminum electrodes, magnetic bar, cables, DC power supply, GO@ZIF-7 adsorbent nanoparticles, and magnified display of an electrochemical cell tank, according to certain embodiments.

FIG. 2 shows an X-ray diffraction (XRD) reference pattern of XRD pattern of graphene oxide (GO), zeolitic imidazolate framework-7 (ZIF-7), and GO@ZIF-7 nanocomposite after treatment, according to certain embodiments.

FIG. 3 shows Fourier-transform infrared (FTIR) spectra of GO, ZIF-7, and GO@ZIF-7 nanocomposite, according to certain embodiments.

FIG. 4A shows scanning electron microscope (SEM) of GO@ZIF-7 after treatment displaying the surface morphology and nature of the material at 3 micrometers (μm) magnification, according to certain embodiments.

FIG. 4B shows SEM of GO@ZIF-7 after treatment displaying the surface morphology and nature of the material at 500 nanometers (nm) magnification, according to certain embodiments.

FIG. 5 is a column graph depicting Pb(II) removal efficiency (%) vs. contact time (min) for electrocoagulation (EC), GO@ZIF-7 adsorption, and the hybrid EC+GO@ZIF-7 system, according to certain embodiments.

FIG. 6A illustrates the interaction factor graph for current density (mA/cm²) and Pb(II) removal at an initial concentration of 400 mg/L, according to certain embodiments.

FIG. 6B illustrates the interaction between Pb(II) initial concentration and adsorbent dosage at a fixed current density and conductivity, after 30 minutes of contact time, according to certain embodiments.

FIG. 6C illustrates the interaction between adsorbent dosage and conductivity at a fixed current density and Pb(II) initial concentration, after 60 minutes of contact time, according to certain embodiments.

FIG. 6D illustrates the interaction between current density and conductivity at a fixed Pb(II) initial concentration and adsorbent dosage, after 90 minutes of contact time, according to certain embodiments.

FIG. 7 is a column graph depicting MO removal (%) as a function of contact time (min) for three systems such as electrocoagulation (EC), GO@ZIF-7 adsorption, and the hybrid EC+GO@ZIF-7 system, according to certain embodiments.

FIG. 8A shows an interaction graph showing the effect of current density and methyl orange (MO) initial concentration at a fixed adsorbent dosage and conductivity after 15 minutes of contact time, according to certain embodiments.

FIG. 8B shows an interaction graph displaying the relationship between MO initial concentration and adsorbent dosage at a fixed current density and conductivity after 30 minutes of contact time, according to certain embodiments.

FIG. 8C shows an interaction graph illustrating the impact of MO initial concentration and current density at a fixed adsorbent dosage and conductivity after 60 minutes of contact time, according to certain embodiments.

FIG. 8D shows an interaction graph highlighting the interaction between MO initial concentration and conductivity at a fixed current density and adsorbent dosage after 90 minutes of contact time, according to certain embodiments.

FIG. 9 is a column graph depicting o-cresol (OC) removal efficiency (%) vs. contact time (min) for EC, GO@ZIF-7 adsorption, and the hybrid EC+GO@ZIF-7 system, according to certain embodiments.

FIG. 10A is a graph depicting the effect of current density and OC initial concentration at a fixed adsorbent dosage and conductivity after 15 minutes of contact time, according to certain embodiments.

FIG. 10B is a graph depicting the relationship between OC initial concentration and adsorbent dosage at a fixed current density and conductivity after 30 minutes of contact time, according to certain embodiments.

FIG. 10C is a graph depicting the impact of OC initial concentration and current density at a fixed adsorbent dosage and conductivity after 60 minutes of contact time, according to certain embodiments.

FIG. 10D is a graph depicting the interaction between current density and conductivity at a fixed OC initial concentration and adsorbent dosage after 90 minutes of contact time, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Embodiments of the present disclosure will now be described more fully hereinafter with reference to the accompanying drawings, in which some, but not all embodiments of the disclosure are shown.

As used herein, the words “about,” “approximately,” or “substantially similar” may be used when describing magnitude and or position to indicate that the value and/or position described is within a reasonable range of values and/or positions. For example, a numeric value may have a value that is +/−0.1% of the stated value (or range of values), +/−1% of the slated value (or range of values), +/−2% of the stated value (or range of values), +/−5% of the slated value (or range of values), +/−10% of the staled value (or range of values), +/−15% of the stated value (or range of values), or +/−20% of the stated value (or range of values). Within the description of this disclosure, where a numerical limit or range is stated, the endpoints are included unless stated otherwise. Also, all values and subranges within a numerical limit or range are specifically included as if explicitly written out.

The present disclosure is intended to include all hydration states of a given compound or formula, unless otherwise noted or when heating a material.

In addition, the present disclosure is intended to include all isotopes of atoms occurring in the present compounds and complexes. Isotopes include those atoms having the same atomic number but different mass numbers. By way of general example, and without limitation, isotopes of hydrogen include deuterium and tritium.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100 wt. %.

As used herein, the term “nanocomposite” refers to a material having multiple phases embedded in a polymeric matrix wherein at least one of the phases comprises nanoparticles.

As used herein, the term “dye” refers to a substance used to impart color to materials by absorbing certain wavelengths of light while reflecting others, resulting in the visible coloration of the material. The persistence and solubility of dyes in water and other solvents make them difficult to remove, leading to potential environmental and health hazards.

As used herein, the term “dimension of particles” refers to the physical size and shape of individual particles in a material, typically measured in terms of their diameter or characteristic lengths. These dimensions are often expressed in units such as micrometers (μm) or nanometers (nm) and are used to describe the behavior, surface area, and reactivity of the particles in various applications.

As used herein, the term “adsorption capacity” refers to the maximum quantity of a substance/dye that a material can adsorb onto its surface under specific conditions.

As used herein, the term “removal efficiency” refers to the percentage of a target substance eliminated from a system or process. It is a measure performance in applications like filtration, water treatment, and pollution control.

As used herein, the term ‘contacting electrodes’ refers to the process in which electrodes are placed in direct contact with a solution or material to facilitate a reaction, such as electrolysis, electrocoagulation, or adsorption. In this context, electrodes, typically made of conductive materials like aluminum or iron, are submerged in a solution, and an electrical current is applied. This setup enables various chemical or physical processes, such as pollutant removal, by creating reactions at the electrode surfaces.

As used herein, the term ‘purification” refers to a process used to remove metal salts, dyes, and other impurities from water, making it suitable for human consumption, agriculture, and industrial use. Utilizing techniques such as reverse osmosis, electrocoagulation, and distillation, purification systems effectively separate salt and contaminants from water to produce fresh, potable water.

As used herein, the term “aqueous solution” refers to a solution in which water acts as the solvent, dissolving other substances, known as solutes. The solutes can be solids, liquids, or gases, and once dissolved, they form a homogeneous mixture with the water.

As used herein, the term “zeolitic material” refers to a material having the crystalline structure or three-dimensional framework of a zeolite, but not always having the elemental composition of a zeolite. Zeolites are porous silicate or aluminosilicate minerals that occur in nature. Elementary building units of zeolites are SiO₄ (and if appropriate, AlO₄) tetrahedra. Adjacent tetrahedra are linked at their corners via a common oxygen atom, which results in an inorganic macromolecule with a three-dimensional framework (frequently referred to as the zeolite framework). The three-dimensional framework of a zeolite also includes channels, channel intersections, and/or cages having dimensions in the range of 0.1-10 nanometers (nm), preferably 0.2-5 nm, more preferably 0.2-2 nm. Water molecules may be present inside these channels, channel intersections, and/or cages. Zeolites which are devoid of aluminum may be referred to as “all-silica zeolites” or “aluminum-free zeolites”. Some zeolites which are substantially free of, but not devoid of, aluminum is referred to as “high-silica zeolites”. Sometimes, the term “zeolite” is used to refer exclusively to aluminosilicate materials, excluding aluminum-free zeolites or all-silica zeolites.

In some embodiments, the zeolitic material has a three-dimensional framework that is at least one zeolite framework selected from the group consisting of a 4-membered ring zeolite framework, a 6-membered ring zeolite framework, a 10-membered ring zeolite framework, and a 12-membered ring zeolite framework. The zeolite may have a natrolite framework (e.g. gonnardite, natrolite, mesolite, paranatrolite, scolecite, and tetranatrolite), edingtonite framework (e.g. edingtonite and kalborsite), thomsonite framework, analcime framework (e.g. analcime, leucite, pollucite, and wairakite), phillipsite framework (e.g. harmotome), gismondine framework (e.g. amicite, gismondine, garronite, and gobbinsite), chabazite framework (e.g. chabazite-series, herschelite, willhendersonite, and SSZ-13), faujasite framework (e.g. faujasite-series, Linde type X, and Linde type Y), mordenite framework (e.g. maricopaite and mordenite), heulandite framework (e.g. clinoptilolite and heulandite-series), stilbite framework (e.g. barrerite, stellerite, and stilbite-series), brewsterite framework, or cowlesite framework. In some embodiments, the porous silicate and/or aluminosilicate matrix is a zeolitic material having a zeolite framework selected from the group consisting of ZSM-5, ZSM-8, ZSM-11, ZSM-12, ZSM-18, ZSM-23, ZSM-35, and ZSM-39.

As used herein, the term “zeolitic material” refers to a multiphase material where one of the phases has dimensions in the nanometer range, typically less than 100 nm. By combining materials at the nanoscale, nanocomposites exhibit enhanced properties such as improved mechanical strength, thermal stability, electrical conductivity, and chemical resistance. These materials are used in a wide range of applications, including electronics, environmental remediation, energy storage, and biomedical devices, due to their tailorable properties and enhanced performance compared to traditional composites.

Aspects of the present disclosure are directed toward a method for desalinating an aqueous solution utilizing a nanocomposite material composed of graphene oxide (GO) and zeolitic imidazolate framework-7 (ZIF-7), referred to as GO@ZIF-7 using a hybrid electrocoagulation/adsorption (EC/A) system. The method of the present disclosure exhibits exceptional efficiency in removing contaminants such as Pb(II), methyl orange (MO), and o-cresol (OC) from the solution.

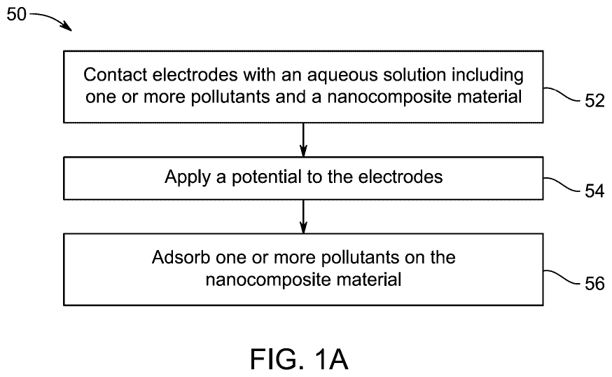

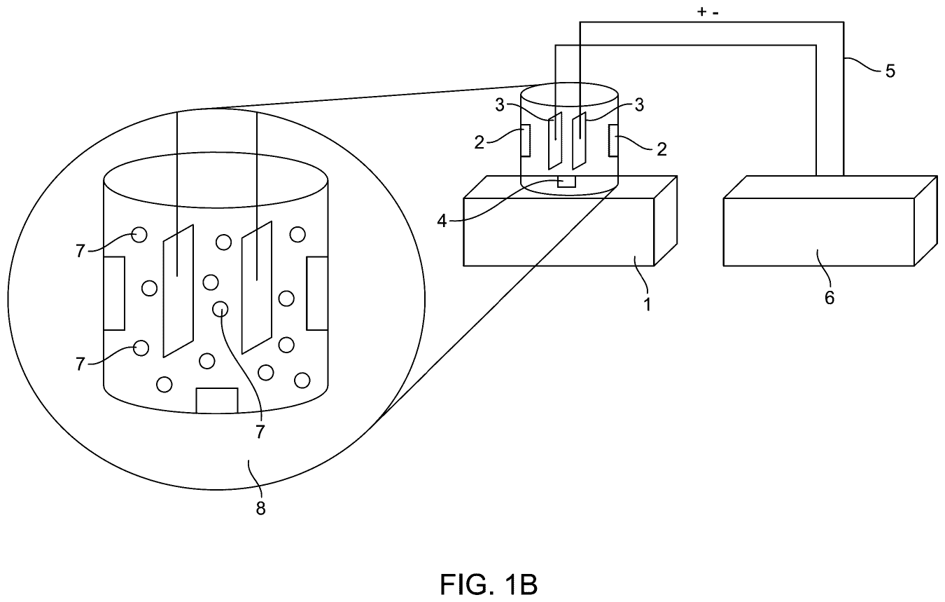

According to a first aspect of the present disclosure, a method of water purification is described. FIG. 1 illustrates a schematic flow chart of a method 50 of purification. The order in which the method 50 is described is not intended to be construed as a limitation, and any number of the described method steps can be combined to implement the method 50. Additionally, individual steps may be removed or skipped from the method 50 without departing from the spirit and scope of the present disclosure.

At step 52, the method 50 includes contacting electrodes with an aqueous solution. The electrodes include a working electrode, a reference electrode, and a counter electrode with the aqueous solution. The working electrode may be a carbon, titanium, stainless steel, platinum, nickel, copper, or other electrode, which may be further modified. In this preferred embodiment, it is an aluminum electrode.

The reference electrode is an electrode that has a stable and well-known electrode potential. The high stability of the electrode potential is usually reached by employing a redox system with constant (buffered or saturated) concentrations of each relevant species of the redox reaction. A reference electrode may enable a potentiostat to deliver a stable voltage to the working or counter electrodes. The reference electrode may be a standard hydrogen electrode (SHE), a normal hydrogen electrode (NHE), a reversible hydrogen electrode (RHE), a saturated calomel electrode (SCE), a copper-copper (II) sulfate electrode (CSE), a silver chloride electrode (Ag/AgCl), a pH-electrode, a palladium-hydrogen electrode, a dynamic hydrogen electrode (DHE), a mercury-mercurous sulfate electrode, mercury/mercuric oxide (Hg/HgO) electrode, or some other type of electrode. In a preferred embodiment, a reference electrode is an Ag/AgCl electrode. However, in some embodiments, the electrochemical cell does not include a third electrode.

In some embodiments, the counter electrode is made from a material selected from the group consisting of platinum, gold, and carbon. In some embodiments, the counter electrode may contain an electrically-conductive material such as platinum, platinum-iridium alloy, iridium, titanium, titanium alloy, stainless steel, gold, cobalt alloy, and/or some other electrically-conductive material, where an “electrically-conductive material” as defined here is a substance with an electrical resistivity of at most 10⁻⁶ Ω·m, preferably at most 10⁻⁷ Ω·m, more preferably at most 10⁻⁸ Ω·m at a temperature of 20-25° C. The form of the counter electrode may be generally relevant only in that it needs to supply sufficient current to the electrolyte solution to support the current required for the electrochemical reaction of interest. The counter electrode material should thus be sufficiently inert to withstand the chemical conditions in the electrolyte solution, such as acidic or basic pH values, without substantially degrading during the electrochemical reaction. The counter electrode should preferably not leach out any chemical substance that interferes with the electrochemical reaction or might lead to undesirable electrode contamination. In a preferred embodiment, the counter electrode is platinum.

The electrodes are submerged in the aqueous solution. In an embodiment, at least 30%, preferably at least 40%, preferably at least 50%, preferably at least 60%, preferably at least 70% of the electrodes are submerged in the aqueous solution. The aqueous solution includes a pollutant dissolved in water and the nanocomposite material dispersed in the solution. Many environmentally or industrially sourced solutions may be decontaminated with this method, which may contain a complex mix of compounds. In one or more embodiments, the aqueous solution may contain a mix of different but related pollutants, like a solution of several dyes. The aqueous solution may also include pollutants of different types, such as dyes and heavy metals. The aqueous solution may also contain other components which may or may not interact with the nanocomposite material.

The pollutant is at least one selected from the group consisting of a dye, a phenol, a polycyclic aromatic hydrocarbon, an herbicide, a pesticide, a heavy metal and/or combinations thereof. Other pollutants are possible, and many types of pollutants, including unknown contaminants, may be remediated with this method when the pollutants to be remediated have similar properties to those readily adsorbed onto the nanocomposite material. Therefore, the nanocomposite material may be able to absorb a wide range of potential pollutants. Dyes and heavy metals are studied as common and environmentally relevant pollutants.

In some embodiments, the pollutant is a dye. A dye is a colored substance that chemically binds to a material it may be intended to color. Examples of dyes include, but are not limited to: acridine dyes, which are acridine and its derivatives such as acridine orange, acridine yellow, acriflavine, and gelgreen; anthraquinone dyes, which are anthroaquinone and its derivatives such as acid blue 25, alizarin, anthrapurpurin, carminic acid, 1,4-diamno-2,3-dihydroanthraquinone, 7,14-dibenzypyrenequinone, dibromoanthrone, 1,3-dihydroxyanthraquinone, 1,4-dihydroxyanthraquinone, disperse red 9, disperse red 11, indanthrone blue, morindone, oil blue 35, parietin, quinizarine green SS, remazol brilliant blue R, solvent violet 13, 1,2,4-trihydroxyanthraquinone, vat orange 1, and vat yellow 1; diaryl methane dyes such as auramine O, triarylmethane dyes such as acid fuchsin, aluminon, aniline blue WS, aurin, aurintricarboxylic acid, brilliant blue FCF, brilliant green, bromocresol green, bromocresol purple, bromocresol blue, bromophenol blue, bromopyrogallol red, chlorophenol red, coomassie brilliant blue, cresol red, O-cresolphthalein, crystal violet, dichlorofluorescein, ethyl green, fast green FCT, FIASH-EDT2, fluoran, fuchsine, green S, light green SF, malachite green, merbromin, metacresol purple, methyl blue, methyl violet, naphtholphthalein, new fuchsine, pararosaniline, patent blue V, phenol red, phenolphthalein, phthalein dye, pittacal, spirit blue, thymol blue, thymolphthalein, Victoria blue BO, Victoria blue R, water blue, xylene cyanol, and xylenol orange; azo dyes such as acid orange 5, acid red 13, alican yellow, alizarine yellow R, allura red AC, amaranth, amido black 10B, aniline yellow, arylide yellow, azo violet, azorubine, basic red 18, biebrich scarlet, Bismarck brown Y, black 7984, brilliant black BN, brown FK, chrysoine resorcinol, citrus red 2, congo red, D&C red 33, direct blue 1, disperse orange 1, eriochrome black T, evans blue, fast yellow AB, orange 1, hydroxynaphthol blue, janus green B, lithol rubine BK, metanil yellow, methyl orange, methyl red, methyl yellow, mordant brown 33, mordant red 19, naphthol AS, oil red O, oil yellow DE, orange B, orange G, orange GGN, para red, pigment yellow 10, ponceau 2R, prontosil, red 2G, scarlet GN, Sirius red, solvent red 26, solvent yellow 124, sudan black B, sudan I, sudan red 7B, sudan stain, tartrazine, tropaeolin, trypan blue, and yellow 2G; phthalocyanine dyes such as phthalocyanine blue BN, phthalocyanine Green G, Alcian blue, and naphthalocyanine, azin dyes such as basic black 2, mauveine, neutral red, Perkin's mauve, phenazine, and safranin; indophenol dyes such as indophenol and dichlorophenolindophenol; oxazin dyes; oxazone dyes; thiazine dyes such as azure A, methylene blue, methylene green, new methylene blue, and toluidine blue; thiazole dyes such as primuline, stains-all, and thioflavin; xanthene dyes such as 6-carboxyfluorescein, eosin B, eosin Y, erythosine, fluorescein, rhodamine B, rose bengal, and Texas red; fluorone dyes such as calcein, carboxyfluorescein diacetate succinimidyl ester, fluo-3, fluo-4, indian yellow, merbromin, pacific blue, phloxine, and seminaphtharhodafluor; or rhodamine dyes such as rhodamine, rhodamine 6G, rhodamine 123, rhodamine B, sulforhodamine 101, and sulforhodamine B. The above listing of dyes is not meant to be exhaustive. Other dyes may be remediated with this method. In a preferred embodiment, the dye is methyl orange or o-cresol. The behavior of one dye may be used as an example of how other similarly structured dyes would interact with the nanocomposite material.

In some embodiments, the pollutant is a heavy metal. Suitable examples of heavy metals include, but are not limited to, arsenic, cadmium, chromium, lead, mercury, and/or combinations thereof. In a preferred embodiment, the pollutant is a heavy metal, and the heavy metal is lead.

The water is collected from various sources, including but not limited to seawater, brackish coastal waters, wastewater, contaminated water, saline or contaminated saline water, streams (including streams near the ocean), and the like. Other feed streams can originate from a variety of sources. For example, in certain embodiments, at least a portion of the stream used in the method comprises and/or is derived from water from an oil or gas well and/or the effluent of a chemical process, such as the effluent of another purification system or another chemical process.

In some embodiments, the initial concentration of pollutants may be in the range of 10-200 mg/L, preferably with an initial concentration of 20-30 mg/L, preferably 30-40 mg/L, preferably 40-50 mg/L, preferably 50-60 mg/L, preferably 60-80 mg/L, preferably 80-90 mg/L, preferably 90-100 mg/L. In a preferred embodiment, the initial concentration of pollutants is about 100 mg/L in the aqueous solution.

The nanocomposite material includes graphene oxide and a zeolitic imidazolate framework-7 (ZIF-7). Graphene oxide refers to a derivative of graphene that has been chemically modified to introduce oxygen-containing functional groups. These groups, such as hydroxyl, epoxy, and carboxyl, are integrated into the graphene structure, resulting in increased hydrophilicity and improved dispersibility in polar solvents. Graphene oxide retains the unique properties of graphene, such as high surface area, mechanical strength, and electrical conductivity, while exhibiting enhanced reactivity due to functional groups. This makes graphene oxide particularly suitable for various applications, including nanocomposites, sensors, and environmental remediation, as it can interact more effectively with other materials and pollutants. In some embodiments, graphene oxide includes reduced or partially reduced graphene oxide.

In some embodiment, the graphene oxide may be present in an amount of 15 to 50 percent by weight (wt. %) based on a total weight of the nanocomposite material, 25 to 40 percent by weight (wt. %) based on a total weight of the nanocomposite material, 30 to 35 percent by weight (wt. %) based on the total weight of the nanocomposite material. In a preferred embodiment, the graphene oxide is present in an amount of 33 percent by weight (wt. %) based on the total weight of the nanocomposite material.

In some embodiments, the morphology of graphene oxide may be nanosheets, nanowires, nanospheres, nanocrystals, nanorectangles, nanotriangles, nanopentagons, nanohexagons, nanoprisms, nanodisks, nanocubes, nanoribbons, nanoblocks, nanotoroids, nanodiscs, nanobarrels, nanogranules, nanowhiskers, nanoflakes, nanofoils, nanopowders, nanoboxes, nanobeads, nanobelts, nano-urchins, nanoflowers, nanostars, tetrapods, etc., and mixtures thereof.

ZIF-7 refers to a zeolitic imidazolate framework, specifically characterized by its three-dimensional crystalline structure formed from zinc ions coordinated to imidazolate linkers. This metal-organic framework (MOF) exhibits exceptional porosity, high surface area, and tunable pore sizes, making it suitable for various applications, including gas adsorption, separation, and catalysis. ZIF-7 is known for its stability under ambient conditions and has a unique square planar structure, contributing to its ability to capture small molecules and organic pollutants selectively. Its integration into nanocomposites, such as those with graphene oxide, enhances the material's overall functionality, particularly in environmental applications like wastewater treatment and pollutant removal.

In some embodiments, the morphology of nanocomposite GO@ZIF-7 may be nanosheets, nanowires, nanospheres, nanocrystals, nanorectangles, nanotriangles, nanopentagons, nanohexagons, nanoprisms, nanodisks, nanocubes, nanoribbons, nanoblocks, nanotoroids, nanodiscs, nanobarrels, nanogranules, nanowhiskers, nanoflakes, nanofoils, nanopowders, nanoboxes, nanobeads, nanobelts, nano-urchins, nanoflowers, nanostars, tetrapods, etc., and mixtures thereof.

In a preferred embodiment, the GO@ZIF-7 composite exhibits a more diverse morphology from spherical to irregular. This variation in morphology indicates a more complex formation process for ZIF-7 and its composite with GO, reflecting the influence of the interaction between the two components during formation. The irregular shapes can enhance the surface area and porosity of the ZIF-7 framework, potentially improving its efficacy in applications such as adsorption and catalysis.

In some embodiments, nanocomposite GO@ZIF-7 may have particles with dimensions from 0.5 to 5 μm, 0.5 to 1 μm, 0.5 to 2 μm, 0.5 to 3 μm, 0.5 to 4 μm, and 1 to 5 μm. In a preferred embodiment, the nanocomposite GO@ZIF-7 has dimensions ranging from 100 nm to 5 μm. The smaller size facilitates and enhances dispersion within the aqueous solution, maximizing the contact area with the pollutant and the nanocomposite.

The nanocomposite material combines the advantages of graphene oxide and zeolitic imidazolate framework-7 (ZIF-7). Graphene oxide is valued for its mechanical strength, electrical conductivity, and large surface area, making it ideal for reinforcing composites. Its functional groups facilitate effective bonding and uniform dispersion of ZIF-7. Conversely, ZIF-7 contributes exceptional porosity, high surface area, and tunable pore sizes, improving adsorption and catalysis. This synergistic combination enhances mechanical properties, thermal stability, and functionality.

In some embodiments, the concentration of nanocomposite in the aqueous solution may be range from 50 to 600 mg/L, preferably including 50 mg/L, 100 mg/L, 150 mg/L, 200 mg/L, 250 mg/L, 300 mg/L, 350 mg/L, 400 mg/L, 450 mg/L, 500 mg/L, 550 mg/L, and 600 mg/L.

At step 54, the method 50 includes applying a potential to the electrodes. A DC power supply is supplied to control the current density (mA/cm²). In one or more embodiments, the current density is in a range from 0.1 to 5 mA/cm², preferably from 0.5 to 1.5 mA/cm². In one or more embodiments, samples were treated under an applied potential with a current density of approximately 0.1 to 2 mA/cm², 0.5 to 1.5 mA/cm², and 0.8 to 1.2 mA/cm². In some embodiments, the current density was regulated with varying conductivity (4, 8, and 12 mS/cm. This controlled environment allows for precise manipulation of electrochemical conditions to evaluate the effectiveness of the purification process and optimize conditions for specific pollutant removal. Therefore, conditions can be tailored for a specific pollutant waste stream.

In some embodiments, the potential is applied between the electrodes at a temperature range of 10° C.-70° C., preferably about 20° C., preferably about 30° C., preferably about 40° C., preferably about 50° C., preferably about 60° C., preferably about 70° C. In a preferred embodiment, the potential is applied between the electrodes at about 25° C.

In some embodiments, the potential was applied between the electrodes for 15-90 minutes, preferably 15 minutes, 30 minutes, 60 minutes, and 90 minutes.

At step 56, the method 50 includes adsorbing the one or more pollutants on the nanocomposite material. The aqueous solution serves as a medium through which the pollutants, such as organic dyes or heavy metals, can be effectively delivered to the surface of the GO@ZIF-7 nanocomposite. This is aided by the thorough dispersion of the nanocomposite material. The pollutants are adsorbed onto the surface of the nanocomposite material due to physical and electrostatic interactions. The unique structural properties of GO@ZIF-7, characterized by its high surface area and porous framework, facilitate the adsorption of these pollutants, allowing for an increase in contact between the adsorbent and the pollutants. In some embodiments, the nature of the interaction between the nanocomposite and the pollutants in the aqueous solution may be through van der Waals forces, hydrogen bonding, and/or electrostatic interactions.

In some embodiments, the method includes calculating removal efficiency at different exposure times and is based on an initial concentration of 100 mg/L of the pollutant. In some embodiments, pollutants such as lead (Pb(II)), methyl orange, and o-cresol are analyzed with an initial concentration of 100 mg/L over a time range of 5-25 minutes, preferably 5-10 minutes, 10-15 minutes, 15-20 minutes, 20-25 minutes, 25-30 minutes, 30-35 minutes, 35-40 minutes, 40-45 minutes, 45-50 minutes, 50-55 minutes, 55-60 minutes, 60-70 minutes, 70-80 minutes, and 80-90 minutes, with removal efficiencies ranging from 10-15%, preferably 15-25%, preferably 25-30%, preferably 30-45%, preferably 35-50%, preferably 40-50%, preferably 40-50%, preferably 50-60%, preferably 50-65%, preferably 60-75%, preferably 60-80%, preferably 65-75%, preferably 75-85%, preferably 80-85%, and more preferably 80-95%. In some embodiments, removal efficiencies may be greater than 90%.

In a preferred embodiment, removal efficiencies are calculated for lead (Pb(II)) with an initial concentration of 100 mg/L in the aqueous solution using a nanocomposite over preferred times of 15, 30, 60, and 90 minutes, achieving notable removal efficiencies of about 15-25% after 15 minutes, 30 to 45% after 30 minutes, 70-85% after 60 minutes, and 80-95% after 90 minutes.

In a specific embodiment, when the applied potential is zero, the nanocomposite material has a lead (Pb(II)) removal efficiency of 60 to 80% after 90 minutes based on an initial concentration of 100 mg/L of lead in the aqueous solution. This embodiment also represents the lead adsorption performance of the nanocomposite material when they are used as an adsorbent independent of any system to apply voltage.

In a preferred embodiment, removal efficiencies are calculated for methyl orange with an initial concentration of 100 mg/L in the aqueous solution using a nanocomposite over preferred times of 15, 30, 60, and 90 minutes, achieving notable removal efficiencies of about 30 to 45% after 15 minutes, 40 to 55% after 30 minutes, 60-75% after 60 minutes, and 75-90% after 90 minutes.

In another specific embodiment, when the applied potential is zero, the nanocomposite material has a methyl orange removal efficiency of 50 to 65% after 90 minutes based on an initial concentration of 100 mg/L of methyl orange in the aqueous solution. This embodiment also represents the methyl orange adsorption performance of the nanocomposite material when they are used as an adsorbent independent of any system to apply voltage.

In a preferred embodiment, removal efficiencies are calculated for o-cresol with an initial concentration of 100 mg/L in the aqueous solution using a nanocomposite over preferred times of 15, 30, 60, and 90 minutes, achieving removal efficiencies of about 25-35% after 15 minutes, 35 to 50% after 30 minutes, 60-75% after 60 minutes, and 75-90% after 90 minutes.

These results highlight the versatility of GO@ZIF-7 in efficiently removing pollutants across varying concentrations, which is beneficial for practical applications in wastewater treatment. The ability to retain high adsorption capacities at high and low pollutant concentrations demonstrates the nanocomposite's potential for addressing environmental challenges posed by dye pollutants, leading to improved water quality and reduced ecological impact.

The method of the present disclosure combines aluminum electrodes with a nanocomposite of graphene oxide (GO) and zeolitic imidazolate framework-7 (ZIF-7) to enhance the electrocoagulation process. This hybrid system leverages both electrocoagulation and adsorption mechanisms for efficiently removing pollutants from wastewater. The aluminum electrodes facilitate coagulation, while the GO@ZIF-7 nanocomposite improves adsorption, making the system highly effective for treating contaminants such as heavy metals, organic dyes, and other pollutants. This integrated approach maximizes removal efficiency and improves overall treatment performance.

The examples below are intended to illustrate further procedures for preparing and characterizing the adsorbent GO@ZIF-7 nanocomposite for aqueous phase Pb(II), methyl orange (MO), and o-cresol (OC) removal using a hybrid electrocoagulation/adsorption system (EC/A) with aluminum electrodes.

### EXAMPLES

The following examples demonstrate a method of water purification. The examples are provided solely for illustration and are not to be construed as limitations of the present disclosure, as many variations thereof are possible without departing from the spirit and scope of the present disclosure.

### Example 1: Materials and Method: Synthesis of Graphene Oxide (GO)

The improved Hummers method described in references [See: (D. C. Marcano et al., Improved Synthesis of Graphene Oxide, ACS Nano, 2010, 4 (8), 4806-4814) & (S. A. Bahadi et al., Chemically versus thermally reduced graphene oxide: effects of reduction methods and reducing agents on the adsorption of phenolic compounds from wastewater, Emergent Mater, 2023) incorporated herein by reference in its entirety] was employed to synthesize (GO). In this experiment, 360 mL H₂SO₄ and 40 mL H₃PO₄ were mixed in a flask, resulting in a final volume of 400 mL with an H₂SO₄: H₃PO₄ volumetric ratio of 9:1. Subsequently, a quantity of 3 g graphite powder was introduced into the mixture, followed by the gradual incorporation of 18 g potassium permanganate (KMnO₄) under constant agitation. During the addition of graphite powder and KMnO₄, the mixture was kept in an iced water bath to avoid overheating. Subsequently, the reaction mixture was transferred to a water bath kept at 50° C. and stirred for 12 h. Then, the reaction mixture was mixed with approximately 400 g of crushed ice, and then H₂O₂ was gradually introduced until the color of the liquid changed to a dark yellow. Subsequently, the mixture underwent a series of washes using distilled water and a 10 vol % hydrochloric acid (HCl) solution. Following each wash cycle, the solid was recovered using centrifugation at a speed of 8000 rpm. Finally, GO was washed multiple times with a large amount of distilled water to thoroughly eliminate any remaining acid residue before drying it at 50° C. The produced GO was subjected to grinding to produce fine powders before its utilization for the preparation of GO@ZIF-7 nanocomposite.

### Example 2: Synthesis of Zeolitic Imidazolate Framework-7 (ZIF-7) Nanocomposite

The synthesis of ZIF-7 was conducted following the procedure outlined by the Yaghi research group [See: W. Morris et al., The Journal of Physical Chemistry C, 2012, 116, 45, 24084-24090 incorporated herein by reference in its entirety], though with certain alterations. During the experimental procedure, a quantity of 5.94 g of Zn(NO₃)₂·6H₂O was introduced into a solution containing 40 mL of high-performance liquid chromatography (HPLC) grade methanol. A quantity of 9.44 g of benzimidazole was introduced into a distinct beaker, which contained 40 mL of methanol of HPLC quality. The two solutions were subsequently agitated at ambient temperature until the solid components were fully dissolved. Subsequently, the zinc solution was expeditiously introduced into the benzimidazole solution under continuous stirring for duration of one hour at ambient temperature. Subsequently, the concoction was put into a Teflon-lined autoclave reactor and subjected to an elevated temperature of 130° C. for duration of 24 h. Subsequently, the autoclave reactor was extracted from the oven and allowed to undergo natural cooling. Subsequently, the ZIF-7 powder that was synthesized underwent purification by multiple rinses with methanol of HPLC grade. The resultant solid ZIF-7 material was retrieved following each rinse by subjecting it to centrifugation at a speed of 6000 rpm. Subsequently, the ZIF-7 sample underwent a drying process at a temperature of 50° C. The ZIF-7 powder in its dried state was subjected to grinding in order to achieve a fine powder consistency. The ZIF-7 powder was stored in hermetically sealed containers prior to its utilization.

### Example 3: Synthesis of GO@ZIF-7 Nanocomposite

In order to synthesize the GO@ZIF-7 nanocomposite, a total of 5.94 g Zn(NO₃)₂·6H₂O was introduced into 40 mL methanol of HPLC grade. The resulting mixture was then subjected to stirring until complete dissolution of the zinc salt was achieved. Subsequently, a quantity of 0.25 g GO was introduced into the aforementioned zinc solution (the Zn:GO mass ratio in the synthesis solution is 5.2:1), and it was agitated at ambient conditions for a duration of 5 min to facilitate the dispersion of GO particles. Then, the dispersion of GO was subjected to sonication at an amplitude of 50% for a duration of 30 min, utilizing a probe sonicator. In parallel, 40 mL HPLC methanol was added to 9.44 g benzimidazole in a separate container and stirred at ambient temperature until the complete benzimidazole dissolution. Subsequently, the above two solutions were mixed and stirred for 1 h at ambient temperature. Then, the reaction mixture was placed in a Teflon-lined autoclave reactor and incubated at 130° C. for a duration of 24 h. To recover and purify the produced GO@ZIF-7 nanocomposite, the reaction mixture was centrifuged and washed several times with HPLC-grade methanol. Subsequently, the GO@ZIF-7 nanocomposite was dried at 50° C., followed by grinding into fine powder.

### Example 4: Hybrid EC/a System Setup

A stock solution of each pollutant with a concentration of 1000 mg/L was prepared. This stock solution was then used to prepare other pollutant solutions. The initial pH of each respective solution was adjusted using 0.1 M HNO₃ or 0.1 M NaOH solution before each experiment. All experiments were carried out in the same experimental setup which includes an electrochemical cell that consists of a DC power supply used to control the current density (0.5, 1, and 1.5 mA/cm²), a pair of aluminum electrodes dipped in a glass beaker filled with 1.6 L of synthetic solution (50, 100, and 150 mg/L in concentration), with varying conductivity (4, 8, and 12 mS/cm), and GO@ZIF-7 dosage (200, 400, and 600 mg/L). All the experiments were conducted at 25° C. Additionally, the conductivity was regulated at the desired values (i.e., 4, 8, and 12 mS/cm) through the addition of sodium chloride. Furthermore, the stirring speed was kept fixed at 250 rpm throughout all the conducted experiments. FIG. 1B shows a schematic diagram of an experimental setup including magnetic stirrer controller (1), baffles (2), aluminum electrodes (3), magnetic bar (4), cables (5), DC power supply (6), GO@ZIF-7 adsorbent nanoparticles (7), magnified display of an electrochemical cell tank (8). Several samples were collected at time 15, 30, 60, and 90 minutes, (i.e., four samples for each experiment) and filtered using a 0.2 μm filter (Whatman) before subjecting them to analysis.

### Example 5: Characterizations

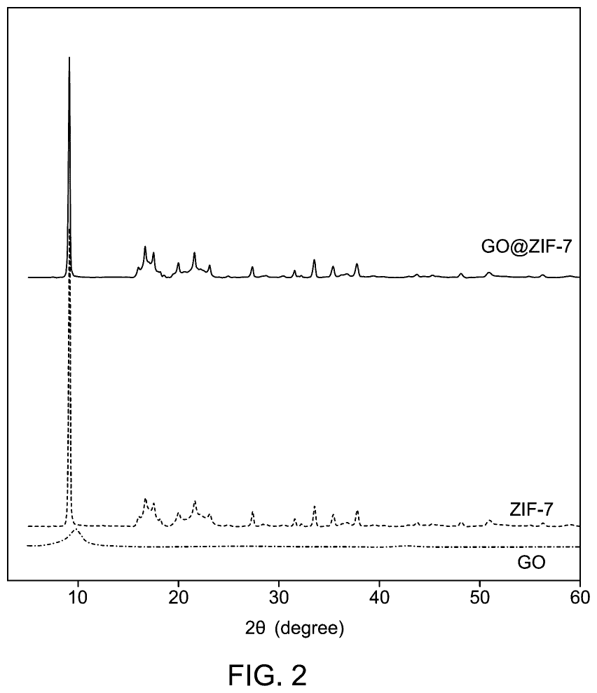

The XRD patterns of GO, ZIF-7, and the GO@ZIF-7 nanocomposite are depicted in FIG. 2. The diffraction peaks of ZIF-7 observed at 20 values of 9.12, 16.0, 16.68, 17.52, 19.98, 21.6, 23.1, 27.39, 31.59, 33.54, 35.43, and 37.8° are consistent with those reported for ZIF-7 synthesized using diethylformamide, ammonia atmosphere, water/ethanol mixture, and N, N-dimethylformamide as the synthesis medium. The presence of a distinct and prominent diffraction peak at an angle of 9.12° suggests a microporous ZIF-7 structure; ZIF-7 can potentially exist in phases I, II, or III depending on the synthesis conditions and media, and the diffraction peaks shown in FIG. 2 suggest the phase III crystalline form for the synthesized ZIF-7. This ZIF-7 phase exhibits a square planar structure with a (4,4) configuration. Such a structure is generated by the coordination of benzimidazolate tetrahedra with quadruply connected corner-shared networks of Zn(II). The ZIF-7 III phase is the densest among all other phases of ZIF-7 and many other ZIFs. Additionally, it is the most stable phase of ZIF-7.

FIG. 2 also displays the XRD diffraction pattern of GO, indicating a solitary weak diffraction peak at 9.8°. The GO diffraction pattern aligns with the pertinent literature on GO synthesized using the improved Hummers method. Furthermore, FIG. 2 illustrates the XRD pattern of the GO@ZIF-7 nanocomposite. Based on the data depicted in FIG. 2, the XRD patterns of both ZIF-7 and GO@ZIF-7 nanocomposite exhibit similarities. The similarity is supported by the weak intensity of the GO diffraction peak at 9.8°, which is approximately 5% of the intensity of the ZIF-7 peak observed at a nearby angle of 9.12°. The close proximity of the small GO and the intense ZIF-7 diffraction peaks may lead to the obscuration of the GO diffraction peak by that of ZIF-7. Furthermore, the relatively small amount of GO present in the GO@ZIF-7 nanocomposite (about 1.63% of the total mass of the ZIF-7 precursors in the synthesis solution) is another possible explanation for the similarities observed in the XRD patterns of ZIF-7 and GO@ZIF-7 nanocomposite.

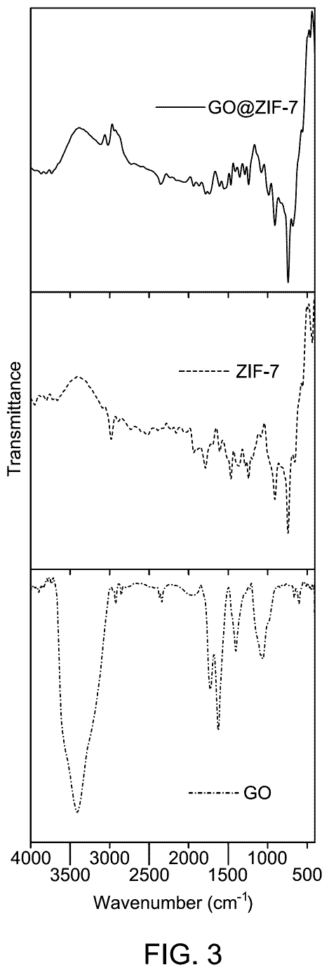

FIG. 3 displays the FTIR spectra of GO, ZIF-7, and the GO@ZIF-7 nanocomposite. The respective GO spectra exhibit a broad and strong absorption peak at around 3417 cm⁻¹. This peak originates from the stretching vibration of O—H bonds, which is a result of the presence of water moisture and/or the deliquescence of KBr. The small peaks located at 2936 and 2855 cm⁻¹ are ascribed to the bending vibration of the C—H bond within the GO framework. The peak at 1730 cm⁻¹ corresponds to the stretching vibration of the C—O bond, whereas the rather high peak at 1636 cm⁻¹ is associated with the vibration of the sp² hybridized carbons in the graphitic structure. Additionally, the absorption peaks at 1385 and 1060 cm⁻¹ correspond to the bending of the alcohol bond (O—H) and the stretching vibrations of the C—H bond, respectively.

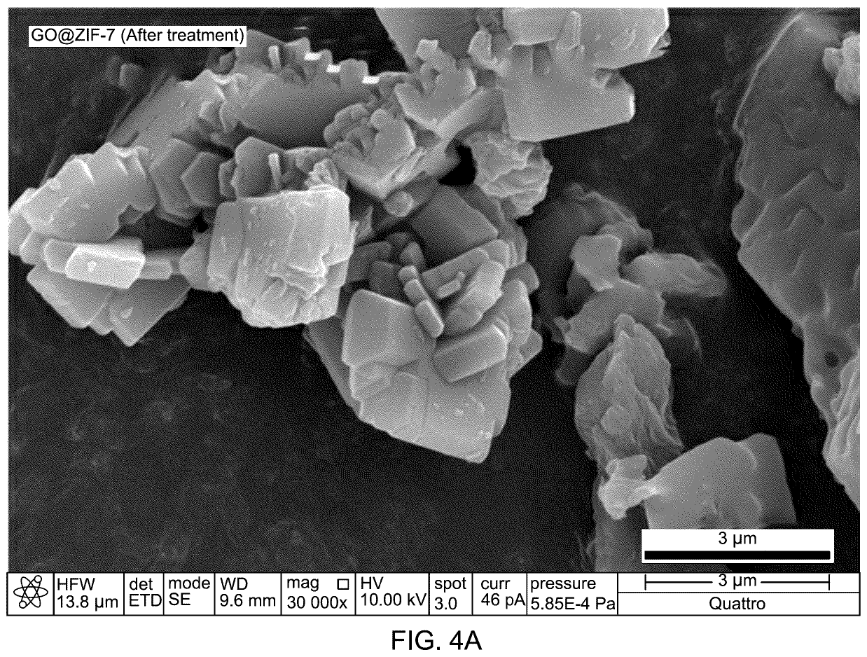

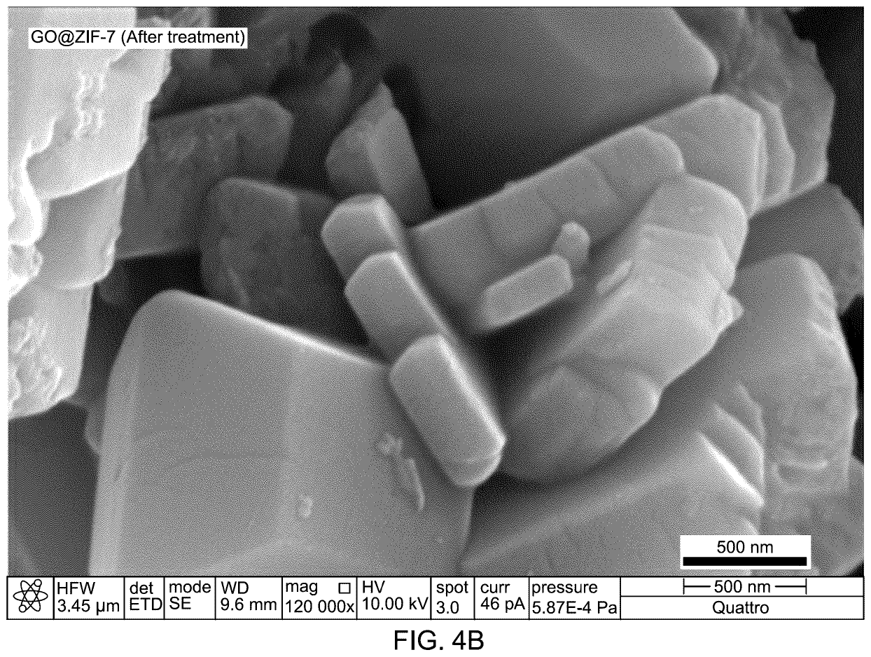

Additionally, FIG. 3 also showcases the FTIR spectra of both ZIF-7 and the GO@ZIF-7 nanocomposite. The spectra of ZIF-7 depicted in FIG. 3 are similar to those documented by Davoodian et al., Zhao et al., and Li et al. Furthermore, the FTIR spectra of ZIF-7 and GO@ZIF-7 nanocomposite exhibit similarities, possibly attributed to the low concentration of GO present in the nanocomposite, as previously mentioned. However, despite the low GO level in the nanocomposite, the incorporation of GO into the ZIF-7 framework led to a substantial enhancement in Pb(II) adsorption according to a preliminary study. FIG. 3 also exhibits many other peaks for ZIF-7 and GO@ZIF-7 within 2700-3100 cm⁻¹ that are likely caused by the stretching vibration of the O—H bonds in the remaining alcohol present after the synthesis and purification processes. Furthermore, the peaks observed within 1700-2000 cm⁻¹ can be attributed to the bending vibration of the C—H bond in the benzyl ring of the organic linker, specifically benzimidazole. On the other hand, the absorption peaks detected within 1500-1700 cm⁻¹ can be attributed to C═C bond stretching in the benzimidazole aromatic ring. The peaks observed within 1300-1365 cm⁻¹ are likely caused by the stretching of the C—N bonds. Similarly, the peak seen at 750 cm⁻¹ is linked to the out-of-plane bending stretching of the aromatic ring, while the peak observed at 900 cm⁻¹ is linked to the in-plane bending stretching of the aromatic ring. Additionally, the peak observed at 430 cm⁻¹ suggests the stretching vibration of the Zn—N bond formed between the organic linker and the Zn atom. Moreover, the scanning electron microscope (SEM) analysis of GO@ZIF-7 (after treatment) as presented in FIGS. 4A-4B, show diverse morphologies from crystalline to irregular and sizes approximately ranging from 100 nm to 5 μm.

### Example 6: Performance of the Hybrid EC/a System Compared to its Components for Pb(II) Removal

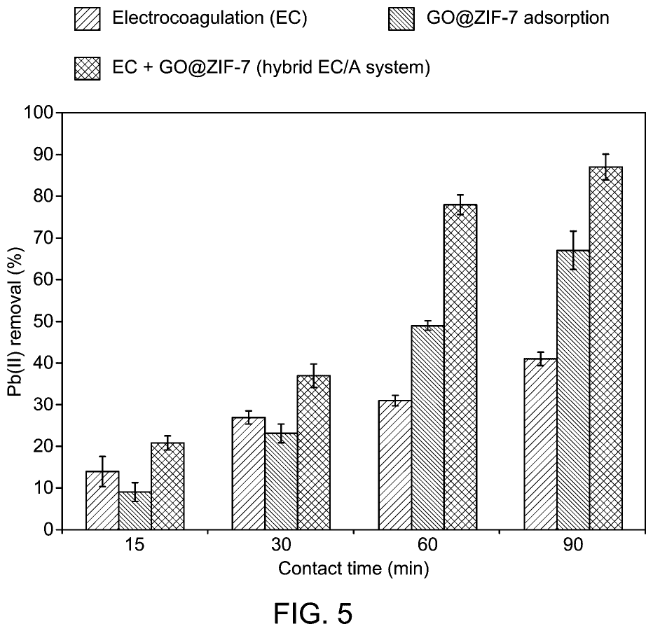

A preliminary study was conducted to investigate and benchmark the performance of the hybrid EC/A system to its components; EC alone and adsorption using GO@ZIF-7 nanocomposite alone. The experimental Pb(II) removal efficiency was calculated using the following equation:

$$Pb ( II ) Removal ( \% ) = \frac{( {C}_{i} - {C}_{f} )}{{C}_{i}} \times 100$$

where Ci and C_{f} represent the Pb(II) initial and final concentrations (mg/L), respectively. The removal of Pb(II) from the aqueous solution using the three techniques is presented in FIG. 5. Comparing these wastewater treatment systems for their efficiency in removing Pb(II) from aqueous solutions reveals noticeable differences between the standalone systems and the developed hybrid EC/A system. The standalone adsorption system showed a maximum removal efficiency of 67% and the standalone EC system showed a removal efficiency of 41% after 90 min of contact time. In contrast, the hybrid EC/A system developed herein has shown remarkable effectiveness, with a Pb(II) removal reaching 87% after 90 min of treatment. This improvement in performance not only demonstrates the successful interaction of the combined treatment techniques (i.e., EC and adsorption) but also positions the hybrid system as a more reliable and effective solution for treating Pb(II) polluted wastewater.

### Example 7: Response Surface Methodology (RSM) Modeling for Pb(II) Removal

Current density, Pb(II) initial concentration, adsorbent dosage, and initial conductivity of the solution were selected as the factors for the RSM modeling. The selection of these factors (i.e., the current density, adsorbent dosage, and conductivity) and their levels was guided by a preliminary study which showed that these factors and their levels affect the removal of Pb(II) using the EC/A process (electrocoagulation paired with GO@ZIF-7 adsorption). The conductivity and current density do affect the electrocoagulant generation rate and consequently removal of the target pollutant. To that end, the preliminary study did assist in choosing the appropriate conductivity and current density ranges. Furthermore, the range of Pb(II) initial concentration range was selected to realize the respective EC/A process applicability over a broad range. Additionally, the adsorbent (GO@ZIF-7) quantity was selected to optimize its dosage for Pb(II) adsorption. The RSM design and all relevant equations and analyses carried out in this study were generated using Stat-Ease software. The RSM-based design of experiments (DOE) as used in the current study was based on the central composite design (CCD) with three levels for each factor, along with the Pb(II) removal efficiency (%) as the response (Table 1).

TABLE 1
The RSM-based design of experiments along with the respective Pb(II) removals.

| | Current | Pb(II) initial | Adsorbent | | Pb(II) Removal (%) | | | |
|---|---|---|---|---|---|---|---|---|
| Exp. | density | concentration | dosage | Conductivity | Sample after (min) | | | |
| No. | (mA/cm²) | (mg/L) | (mg/L) | (mS/cm) | 15 | 30 | 60 | 90 |
| 1 | 1.5 | 150 | 600 | 12 | 30.2 | 72.6 | 79.9 | 86.1 |
| 2 | 0.5 | 50 | 200 | 12 | 32.7 | 68.2 | 74.9 | 85.2 |
| 3 | 1 | 100 | 400 | 16 | 41.8 | 76 | 82.8 | 88.5 |
| 4 | 0.5 | 150 | 200 | 12 | 31.8 | 71.2 | 74.4 | 84.6 |
| 5 | 1 | 100 | 0 | 8 | 29.4 | 45.8 | 63.8 | 74.1 |
| 6 | 0 | 100 | 400 | 8 | 18.9 | 22.2 | 24.5 | 25.8 |
| 7 | 0.5 | 150 | 200 | 4 | 29.1 | 66.1 | 69.4 | 80.5 |
| 8 | 1.5 | 50 | 600 | 12 | 32.8 | 69.2 | 78 | 87.3 |
| 9 | 2 | 100 | 400 | 8 | 26.6 | 66 | 77.3 | 80.1 |
| 10 | 1 | 100 | 400 | 0 | 20.6 | 23.1 | 25.2 | 27.1 |
| 11 | 0.5 | 150 | 600 | 4 | 31.5 | 68.9 | 81.3 | 85.1 |
| 12 | 1.5 | 50 | 200 | 12 | 23.2 | 59.4 | 64.7 | 75.9 |
| 13 | 1.5 | 150 | 600 | 4 | 28.8 | 61.3 | 73.3 | 75.5 |
| 14 | 1.5 | 150 | 200 | 12 | 28.4 | 52.9 | 62.6 | 68.7 |
| 15 | 1 | 200 | 400 | 8 | 32.3 | 67.2 | 73.8 | 79.1 |
| 16 | 1 | 100 | 400 | 8 | 40.2 | 57.8 | 71.2 | 83.5 |
| 17 | 0.5 | 50 | 600 | 12 | 43.8 | 71.7 | 91.3 | 98.4 |
| 18 | 0.5 | 150 | 600 | 12 | 36.5 | 77.8 | 87.7 | 91.3 |
| 19 | 1.5 | 150 | 200 | 4 | 27.3 | 70.9 | 79.1 | 82.9 |
| 20 | 1 | 100 | 800 | 8 | 44.2 | 65.6 | 72.9 | 80.4 |
| 21 | 1.5 | 50 | 600 | 4 | 34.3 | 69.4 | 85.6 | 88.2 |
| 22 | 0.5 | 50 | 200 | 4 | 36.1 | 72.8 | 81.3 | 87 |
| 23 | 1.5 | 50 | 200 | 4 | 30.9 | 68.6 | 73.6 | 82.3 |
| 24 | 0.5 | 50 | 600 | 4 | 35.7 | 74.1 | 82.7 | 87.5 |

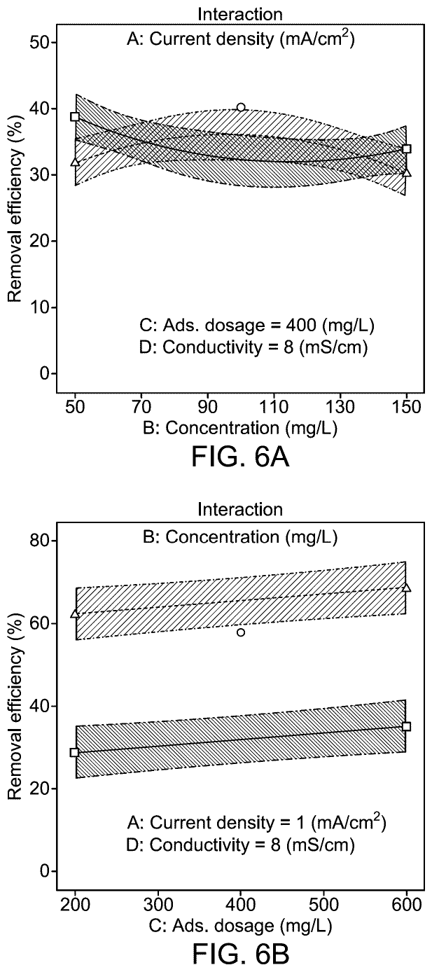

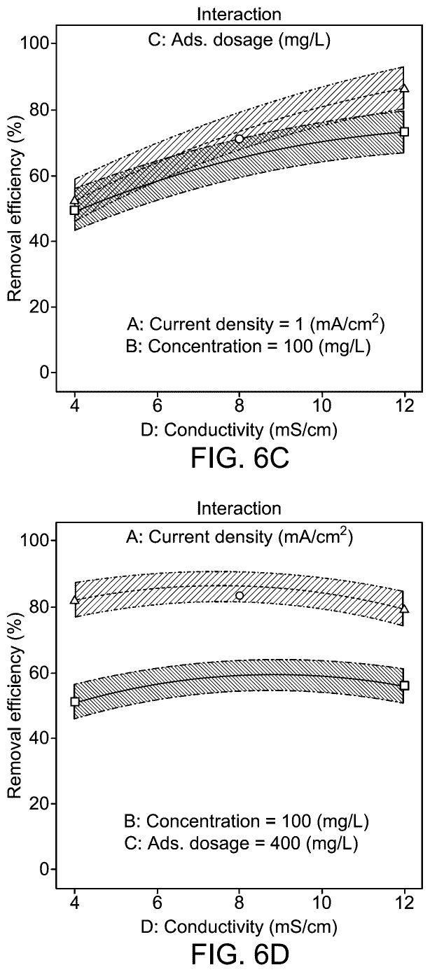

FIGS. 6A-6D show a set of two-factor interaction (2FI) graphs between the studied factors. FIG. 6A for instance demonstrates how the interaction between current density (Factor A) and Pb(II) initial concentration (Factor B) affects the Pb(II) removal efficiency. This interaction is analyzed while maintaining constant levels for the other two factors of the model: adsorbent dosage (Factor C) at 400 mg/L and conductivity (Factor D) at 8 mS/cm. In this graph, the black line represents the trend in Pb(II) removal efficiency as the Pb(II) initial concentration increases from 50 mg/L to 150 mg/L, while keeping the current density fixed at its lowest level of 0.5 mA/cm². On the other hand, the black line (with thin spaces) corresponds to a higher current density of 1.5 mA/cm². The divergence of these lines from parallelism is a sign of an interaction between the current density and Pb(II) initial concentration. Specifically, this variation suggests that the efficiency of Pb(II) removal is not only dependent on either the current density or the initial concentration in isolation but rather on the combined effect of these two factors. It should be noted that parallel lines imply the absence of interaction between the studied factors, while unparallel ones indicate the presence of interaction. The greater the degree to which these lines split away from being parallel, the more powerful the interaction between the studied factors.

### Example 8: Performance of the Hybrid EC/a System Compared to its Components for MO Removal

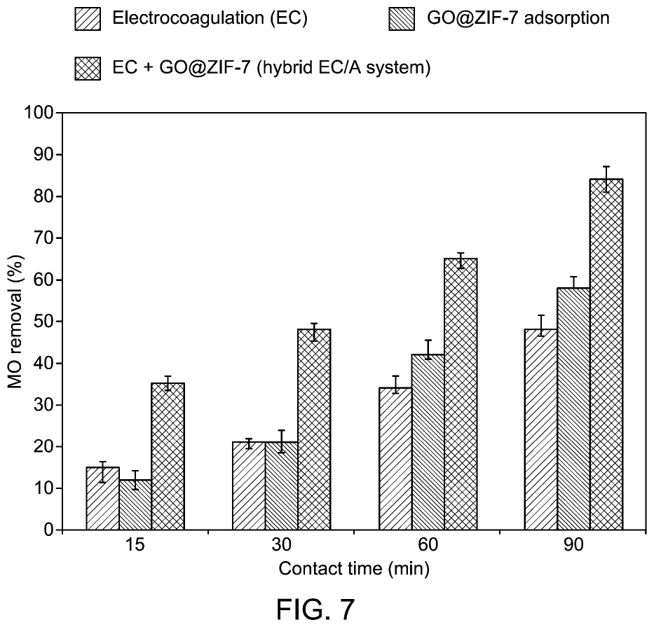

A preliminary investigation was performed to evaluate and compare the performance of the hybrid EC/A system to its individual components; EC alone and adsorption using GO@ZIF-7 nanocomposite alone. The experimental MO removal efficiency was determined using the following equation:

$$MO removal ( \% ) = \frac{( {C}_{i} - {C}_{f} )}{{C}_{i}} \times 100$$

where Ci and C_{f} represent the MO initial and final concentrations (mg/L), respectively. The removal of MO from the aqueous solution using the three techniques is presented in FIG. 7. Analyzing the performance of these wastewater treatment systems in eliminating MO from aqueous solutions reveals notable differences between the standalone and hybrid EC/A systems. The adsorption system on its own achieved a maximum removal efficiency of 58%, and the standalone EC system managed a 48% removal efficiency after 90 minutes of treatment. However, the hybrid EC/A system designed in this study demonstrated impressive efficiency, achieving 84% MO removal after 90 minutes. This enhancement clearly illustrates the successful synergy between EC and adsorption techniques, highlighting the hybrid system as a more dependable and effective approach for treating MO contaminated wastewater.

### Example 9: Response Surface Methodology (RSM) Modeling for MO Removal

Current density, MO initial concentration, adsorbent dosage, and initial conductivity of the solution were selected as the factors for the RSM modeling. The selection of these factors (i.e., the current density, adsorbent dosage, and conductivity) and their levels was guided by a preliminary study which showed that these factors and their levels affect the removal of MO using the EC/A process (electrocoagulation paired with GO@ZIF-7 adsorption). The conductivity and current density do affect the electrocoagulant generation rate and consequently removal of the target pollutant. To that end, the preliminary study did assist in choosing the appropriate conductivity and current density ranges. Furthermore, the range of MO initial concentration range was selected to realize the respective EC/A process applicability over a broad range. Additionally, the adsorbent (GO@ZIF-7) quantity was selected to optimize its dosage for MO adsorption. The RSM design and all relevant equations and analyses carried out in this study were generated using Stat-Ease software. The RSM-based design of experiments (DOE) as used in the current study was based on the central composite design (CCD) with three levels for each factor, along with the MO removal efficiency (%) as the response (Table 2).

TABLE 2
The RSM-based design of experiments along with the respective MO removals.

| | Current | MO initial | Adsorbent | | MO Removal (%) | | | |
|---|---|---|---|---|---|---|---|---|
| Exp. | density | concentration | dosage | Conductivity | Sample after (min) | | | |
| No. | (mA/cm²) | (mg/L) | (mg/L) | (mS/cm) | 15 | 30 | 60 | 90 |
| 1 | 1.5 | 150 | 600 | 12 | 22.3 | 34.7 | 57.8 | 59.9 |
| 2 | 0.5 | 50 | 200 | 12 | 24.6 | 34.5 | 53.5 | 58.2 |
| 3 | 1 | 100 | 400 | 16 | 21.2 | 29.5 | 50.2 | 52.7 |
| 4 | 0.5 | 150 | 200 | 12 | 26.4 | 31.8 | 58.1 | 62.6 |
| 5 | 1 | 100 | 0 | 8 | 24.4 | 64.7 | 72 | 80.2 |
| 6 | 0 | 100 | 400 | 8 | 36.1 | 59.7 | 65.3 | 78.2 |
| 7 | 0.5 | 150 | 200 | 4 | 28.5 | 62.8 | 76.6 | 84.4 |
| 8 | 1.5 | 50 | 600 | 12 | 32.4 | 67 | 70.3 | 81.1 |
| 9 | 2 | 100 | 400 | 8 | 26.6 | 64.4 | 63.9 | 75.8 |
| 10 | 1 | 100 | 400 | 0 | 31.7 | 68.4 | 74.4 | 81.7 |
| 11 | 0.5 | 150 | 600 | 4 | 26.3 | 66.1 | 71.9 | 81.1 |
| 12 | 1.5 | 50 | 200 | 12 | 25.4 | 63.6 | 70 | 78.3 |
| 13 | 1.5 | 150 | 600 | 4 | 27.2 | 61.1 | 62.6 | 78.1 |
| 14 | 1.5 | 150 | 200 | 12 | 26.5 | 63 | 71.2 | 80 |
| 15 | 1 | 200 | 400 | 8 | 22.6 | 62.3 | 70.6 | 78.5 |
| 16 | 1 | 100 | 400 | 8 | 29.6 | 61.2 | 65.4 | 76.5 |
| 17 | 0.5 | 50 | 600 | 12 | 23.6 | 62.7 | 67.1 | 78.2 |
| 18 | 0.5 | 150 | 600 | 12 | 27 | 64.6 | 73.1 | 82.1 |
| 19 | 1.5 | 150 | 200 | 4 | 25.3 | 66.3 | 72.3 | 82.8 |
| 20 | 1 | 100 | 800 | 8 | 33.5 | 55 | 64.8 | 80.8 |
| 21 | 1.5 | 50 | 600 | 4 | 32.2 | 67.8 | 73 | 83.6 |
| 22 | 0.5 | 50 | 200 | 4 | 31.8 | 70 | 75.2 | 84.7 |
| 23 | 1.5 | 50 | 200 | 4 | 28 | 66.6 | 71 | 79.7 |
| 24 | 0.5 | 50 | 600 | 4 | 34.5 | 68.6 | 74.2 | 83.7 |

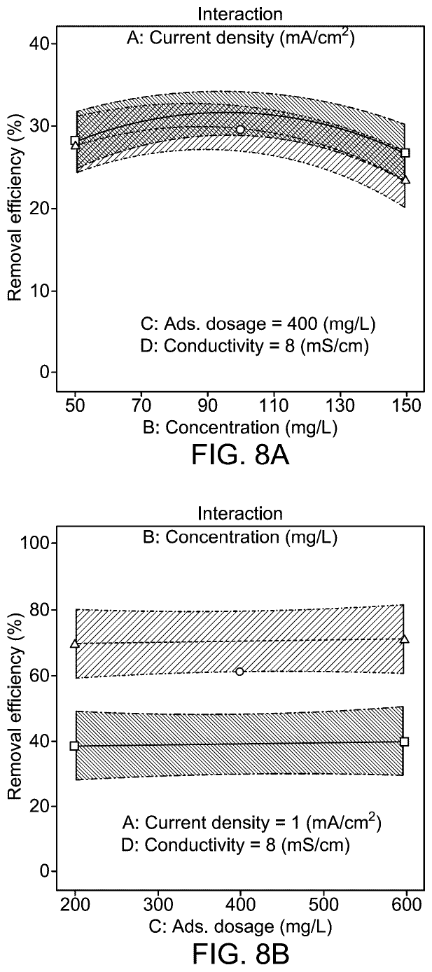

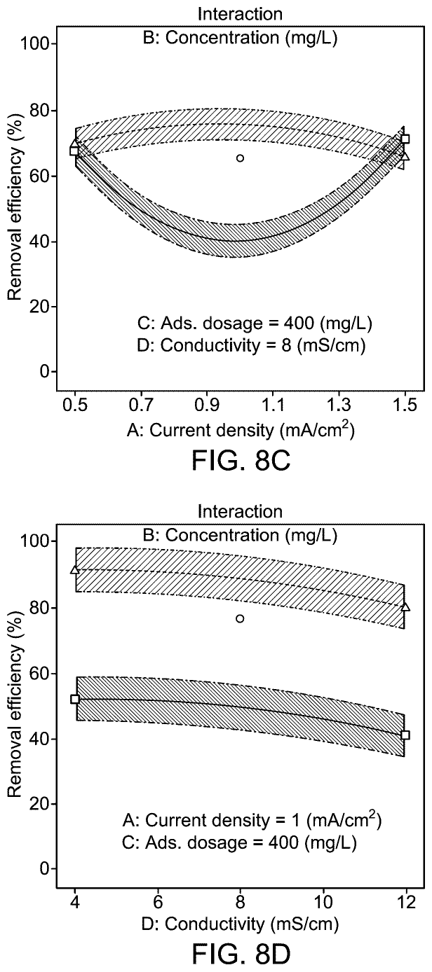

FIGS. 8A-8D show a set of two-factor interaction (2FI) graphs between the studied factors. Accordingly, the unparallel lines shown in FIG. 8A reveals the presence of interaction between factors A and B and confirm that MO removal efficiency is dependent on the interaction between these two factors.

### Example 10: Performance of the Hybrid EC/a System Compared to its Components for OC Removal

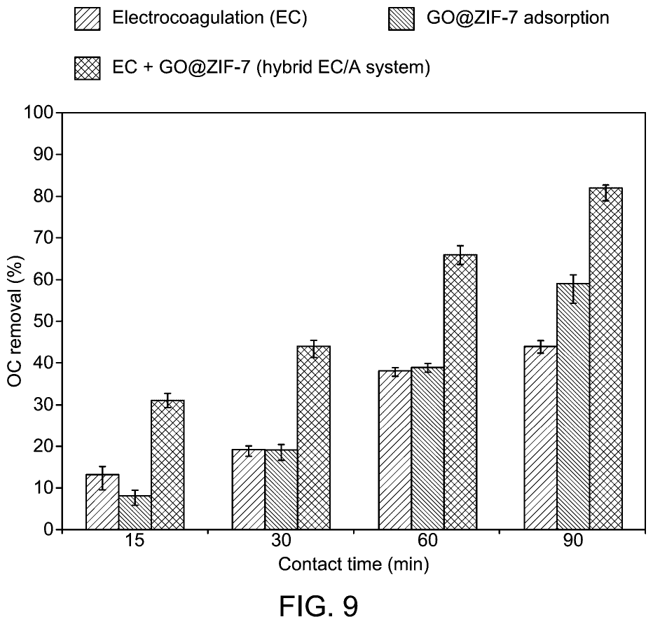

A preliminary study was conducted to investigate and benchmark the performance of the hybrid EC/A system to its components; EC alone and adsorption using GO@ZIF-7 nanocomposite alone. The experimental OC removal efficiency was calculated using the following equation:

$$OC removal ( \% ) = \frac{( {C}_{i} - {C}_{f} )}{{C}_{i}} \times 100$$

where Ci and C_{f} represent the OC initial and final concentrations (mg/L), respectively. FIG. 9 illustrates the removal of OC from the aqueous solution using the three different techniques. Comparing these wastewater treatment methods for their ability to eliminate OR reveals clear differences between the standalone system and the developed hybrid EC/A system. The standalone adsorption system achieved a maximum removal efficiency of 59%, while the standalone EC system managed a removal efficiency of 44% after 90 minutes of operation. In contrast, the newly developed hybrid EC/A system demonstrated notable effectiveness, with OC removal reaching 82% after 90 minutes of treatment. The enhancement in performance highlights the successful interaction between EC and adsorption techniques, establishing the hybrid system as a more reliable solution for treating wastewater contaminated with OC.

### Example 11: Response Surface Methodology (RSM) Modeling for OC Removal

Current density, OC initial concentration, adsorbent dosage, and initial conductivity of the solution were selected as the factors for the RSM modeling. The selection of these factors (i.e., the current density, adsorbent dosage, and conductivity) and their levels was guided by a preliminary study which showed that these factors and their levels affect the removal of OC using the EC/A process (electrocoagulation paired with GO@ZIF-7 adsorption). The conductivity and current density do affect the electrocoagulant generation rate and consequently removal of the target pollutant. To that end, the preliminary study did assist in choosing the appropriate conductivity and current density ranges. Furthermore, the range of OC initial concentration range was selected to realize the respective EC/A process applicability over a broad range. Additionally, the adsorbent (GO@ZIF-7) quantity was selected to optimize its dosage for OC adsorption. The RSM design and all relevant equations and analyses carried out in this study were generated using Stat-Ease software. The RSM-based design of experiments (DOE) as used in the current study was based on the central composite design (CCD) with three levels for each factor, along with the OC removal efficiency (%) as the response (Table 3).

TABLE 3
The RSM-based design of experiments along with the respective OC removals.

| | Current | OC initial | Adsorbent | | OC Removal (%) | | | |
|---|---|---|---|---|---|---|---|---|
| Exp. | density | concentration | dosage | Conductivity | Sample after (min) | | | |
| No. | (mA/cm²) | (mg/L) | (mg/L) | (mS/cm) | 15 | 30 | 60 | 90 |
| 1 | 1.5 | 150 | 600 | 12 | 28.9 | 67.0 | 74.6 | 79.3 |
| 2 | 0.5 | 50 | 200 | 12 | 30.1 | 64.7 | 71.6 | 82.9 |
| 3 | 1 | 100 | 400 | 16 | 35.2 | 72.0 | 80.3 | 86.2 |
| 4 | 0.5 | 150 | 200 | 12 | 30.8 | 66.7 | 72.4 | 80.6 |
| 5 | 1 | 100 | 0 | 8 | 26.6 | 43.0 | 61.6 | 71.2 |
| 6 | 0 | 100 | 400 | 8 | 30.8 | 63.5 | 69.9 | 77.4 |
| 7 | 0.5 | 150 | 200 | 4 | 27.9 | 62.3 | 66.2 | 78.2 |
| 8 | 1.5 | 50 | 600 | 12 | 31.3 | 63.4 | 74.9 | 84.4 |
| 9 | 2 | 100 | 400 | 8 | 24.9 | 63.3 | 74.7 | 79.1 |
| 10 | 1 | 100 | 400 | 0 | 27.0 | 58.2 | 65.9 | 76.9 |
| 11 | 0.5 | 150 | 600 | 4 | 27.9 | 63.5 | 74.1 | 83.1 |
| 12 | 1.5 | 50 | 200 | 12 | 26.4 | 65.8 | 74.0 | 83.4 |
| 13 | 1.5 | 150 | 600 | 4 | 31.1 | 61.7 | 70.0 | 79.1 |
| 14 | 1.5 | 150 | 200 | 12 | 27.4 | 64.3 | 72.4 | 80.9 |
| 15 | 1 | 200 | 400 | 8 | 29.8 | 61.4 | 71.6 | 78.8 |
| 16 | 1 | 100 | 400 | 8 | 37.0 | 54.1 | 68.5 | 83.0 |
| 17 | 0.5 | 50 | 600 | 12 | 33.7 | 68.8 | 76.2 | 83.5 |
| 18 | 0.5 | 150 | 600 | 12 | 34.0 | 72.6 | 82.4 | 86.0 |
| 19 | 1.5 | 150 | 200 | 4 | 27.1 | 65.3 | 77.1 | 79.2 |
| 20 | 1 | 100 | 800 | 8 | 40.4 | 62.1 | 69.6 | 79.4 |
| 21 | 1.5 | 50 | 600 | 4 | 32.8 | 67.0 | 81.7 | 85.4 |
| 22 | 0.5 | 50 | 200 | 4 | 34.3 | 68.3 | 74.7 | 82.1 |
| 23 | 1.5 | 50 | 200 | 4 | 28.7 | 63.2 | 67.0 | 75.7 |
| 24 | 0.5 | 50 | 600 | 4 | 33.3 | 69.4 | 77.3 | 81.8 |

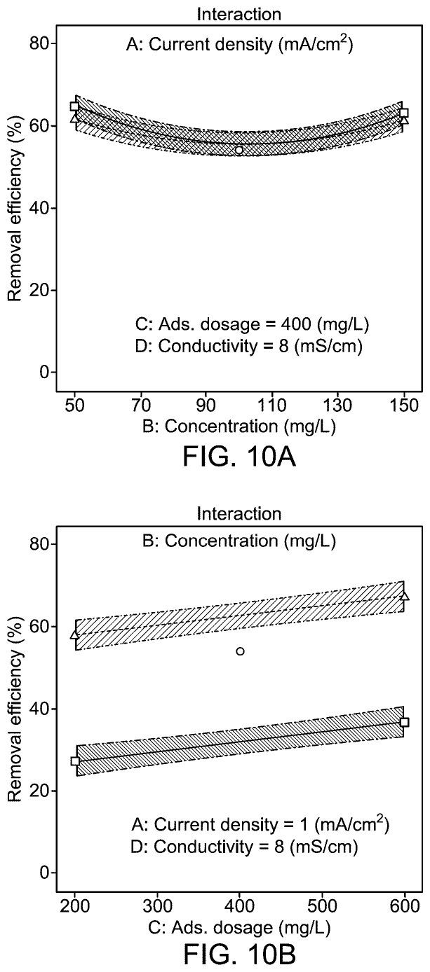

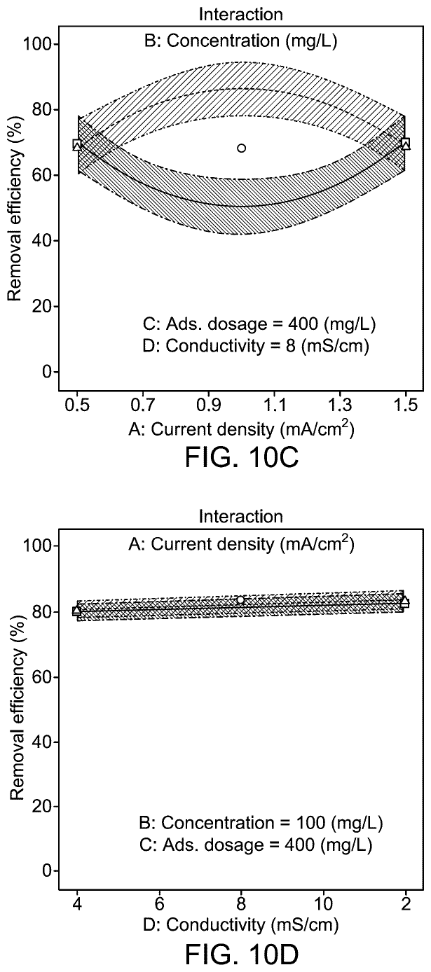

FIGS. 10A-10D show a set of 2FI graphs between the studied factors. FIG. 10B, for instance, depicts the interaction between factor B and factor C (i.e., adsorbent dosage). FIG. 10B shows parallel lines representing the interaction between factor B and factor C, suggesting that the interaction between these two factors is statistically insignificant. FIGS. 10A-10D provide insights into how various factors and their interactions affect the efficiency of OC removal using the hybrid EC/A system. These insights can guide further experiments and/or process refinements.

Numerous modifications and variations of the present disclosure are possible in light of the above teachings. It is therefore to be understood that within the scope of the appended claims, the invention may be practiced otherwise than as specifically described herein.

1. A method of water purification, comprising:
contacting electrodes with an aqueous solution,
wherein the aqueous solution comprises one or more pollutants and a nanocomposite material,
wherein the nanocomposite material comprises graphene oxide and zeolitic imidazolate framework-7,
wherein the nanocomposite material is in the shape of particles having the longest dimension of 0.5 to 5 μm,
applying a potential to the electrodes, and
adsorbing the one or more pollutants on the nanocomposite material.

2. The method of claim 1, wherein the graphene oxide is present in the nanocomposite material in an amount of 25 to 40 percent by weight (wt. %) based on a total weight of the nanocomposite material.

3. The method of claim 2, wherein the graphene oxide is present in the nanocomposite material in an amount of 30 to 35 percent by weight (wt. %) based on the total weight of the nanocomposite material.

4. The method of claim 1, wherein the nanocomposite material has a lead (Pb(II)) removal efficiency of 15 to 25% after 15 minutes based on an initial concentration of 100 mg/L of lead in the aqueous solution.

5. The method of claim 1, wherein the nanocomposite material has a lead (Pb(II)) removal efficiency of 30 to 45% after 30 minutes based on an initial concentration of 100 mg/L of lead in the aqueous solution.

6. The method of claim 1, wherein the nanocomposite material has a lead (Pb(II)) removal efficiency of 70 to 85% after 60 minutes based on an initial concentration of 100 mg/L of lead in the aqueous solution.

7. The method of claim 1, wherein the nanocomposite material has a lead (Pb(II)) removal efficiency of 80 to 95% after 90 minutes based on an initial concentration of 100 mg/L of lead in the aqueous solution.

8. The method of claim 1, wherein the nanocomposite material has a methyl orange removal efficiency of 30 to 45% after 15 minutes based on an initial concentration of 100 mg/L of methyl orange in the aqueous solution.

9. The method of claim 1, wherein the nanocomposite material has a methyl orange removal efficiency of 40 to 55% after 30 minutes based on an initial concentration of 100 mg/L of methyl orange in the aqueous solution.

10. The method of claim 1, wherein the nanocomposite material has a methyl orange removal efficiency of 60 to 75% after 60 minutes based on an initial concentration of 100 mg/L of methyl orange in the aqueous solution

11. The method of claim 1, wherein the nanocomposite material has a methyl orange removal efficiency of 75 to 90% after 90 minutes based on an initial concentration of 100 mg/L of methyl orange in the aqueous solution.

12. The method of claim 1, wherein the nanocomposite material has an o-cresol removal efficiency of 25 to 35% after 15 minutes based on an initial concentration of 100 mg/L of o-cresol in the aqueous solution.

13. The method of claim 1, wherein the nanocomposite material has an o-cresol removal efficiency of 35 to 50% after 30 minutes based on an initial concentration of 100 mg/L of o-cresol in the aqueous solution.

14. The method of claim 1, wherein the nanocomposite material has an o-cresol removal efficiency of 60 to 75% after 60 minutes based on an initial concentration of 100 mg/L of o-cresol in the aqueous solution.

15. The method of claim 1, wherein the nanocomposite material has an o-cresol removal efficiency of 75 to 90% after 90 minutes based on an initial concentration of 100 mg/L of o-cresol in the aqueous solution.

16. The method of claim 1, wherein the applied potential has a current density of 0.1 to 2 mA/cm².

17. The method of claim 16, wherein the applied potential has a current density of 0.5 to 1.5 mA/cm².

18. The method of claim 17, wherein the applied potential has a current density of 0.8 to 1.2 mA/cm².

19. The method of claim 1, wherein the applied potential is zero and the nanocomposite material has a lead (Pb(II)) removal efficiency of 60 to 80% after 90 minutes based on an initial concentration of 100 mg/L of lead in the aqueous solution.

20. The method of claim 1, wherein the applied potential is zero and the nanocomposite material has a methyl orange removal efficiency of 50 to 65% after 90 minutes based on an initial concentration of 100 mg/L of methyl orange in the aqueous solution.
